(19) United States
(12) Patent Application Publication
(10) Pub. No.: US 2024/0204568 A1
(43) Pub. Date: Jun. 20, 2024

(54) High-Order Parity-Time Symmetry Wireless Power Transfer System and Method

(71) Applicant: Tongji University, Shanghai (CN)

(72) Inventors: Chao Zeng, Shanghai (CN); Yong Sun, Shanghai (CN); Guo Li, Shanghai (CN); Zhiwei Guo, Shanghai (CN); Kejia Zhu, Shanghai (CN); Jun Jiang, Shanghai (CN); Yunhui Li, Shanghai (CN); Kai Fang, Shanghai (CN); Yewen Zhang, Shanghai (CN); Haitao Jiang, Shanghai (CN); Hong Chen, Shanghai (CN)

(21) Appl. No.: 17/309,745

(22) PCT Filed: Apr. 12, 2021
(86) PCT No.: PCT/CN2021/086468

§ 371 Date: Aug. 11, 2023

(30) Foreign Application Priority Data
Dec. 2, 2020 (CN) 202011403919.7

(51) Int. Cl. H02J 50/12; H02J 50/70

(52) U.S. Cl. CPC H02J 50/12; H02J 50/70

(57) ABSTRACT

The present invention relates to a high-order parity-time (PT) symmetry wireless power transfer (WPT) system and method. The method includes the following steps: providing an N-order composite coil which includes N resonance circuits, where N is an odd number; providing an M-order composite coil which includes M resonance circuits, where M is an even number; connecting a scattering capacitor to end portions of two adjacent resonance circuits; coupling the first resonance circuits in the two composite coils to realize WPT; connecting a load to an alternating current power supply; and adjusting a capacitor in the resonance circuit symmetrical to the two first resonance circuits according to a change in coupling strength caused by a change in coupling distance in a WPT process to obtain an optimal transfer efficiency. According to the present invention, frequency tracking is not required for WPT by utilizing a unique pure real number eigenfrequency which is unrelated to a coupling distance and is represented by odd-order PT symmetry, and a capacitor size is adjusted according to a change in coupling distance to obtain a better transfer efficiency.

### TECHNICAL FIELD

The present invention relates to the technical field of wireless power transfer (WPT), and in particular, to a high-order parity-time (PT) symmetry WPT system and method.

### RELATED ART

In recent years, the concept of PT symmetry in quantum mechanics has been widely studied. The PT symmetry is invariant under joint space and time inversion operations. There are eigenvalues of pure real numbers in PT symmetry systems, where an exceptional point (EP) occurs in a phase change between symmetry protection and symmetry destruction phases. In optical and photonic systems, PT symmetry and interactions between gain and loss, as well as coupling strengths between different components, can produce many interesting phenomena, such as coherent perfect absorption, topological phase control, chiral modes, and enhanced sensing. In addition, the concept of PT symmetry is also used in a WPT technology to realize stable transfer. A radio-frequency (RF) WPT technology has attracted great interest in a series of practical applications such as implantable medical devices and electric vehicles. In general, a WPT system consists essentially of two magnetically coupled resonance coils (a transmitting coil and a receiving coil) placed at a source and a load end, respectively. The coupling rates between the source and the transmitting coil, between the transmitting coil and the receiving coil, and between the receiving coil and the load end are adjusted respectively, and effective power transfer can be obtained. However, in a second-order PT symmetry electronic system, an exact PT symmetry phase requires a high coupling strength, which leads to the occurrence of bifurcated pure real eigenfrequencies. Therefore, it is necessary to adjust an operating frequency to track changed pure real number eigenfrequencies related to coupling strength. In addition, when the system is in a broken PT phase (i.e. a weak coupling region), although a real part of the eigenfrequency is unchanged, the transfer efficiency of the system decreases sharply with the increase of a coupling distance due to the increase of an imaginary part of the eigenfrequency.

### SUMMARY

The present invention aims to overcome the defects of the prior art, and provides a high-order PT symmetry WPT system and method, which solve the problem that the transfer efficiency of a system decreases sharply with the increase of a coupling distance due to the increase of an imaginary part of an eigenfrequency in an existing frequency tracking WPT technology. Frequency tracking is not required, additional coils or optimized coil structures are not required, and a better transfer efficiency can be obtained within a large coupling distance range.

A technical scheme for achieving the foregoing purpose is as follows:

The present invention provides a high-order PT symmetry WPT method, including the following steps:
providing an N-order composite coil, where the provided N-order composite coil includes N resonance circuits, N is an odd number greater than or equal to 1, and when N is greater than or equal to 3, a scattering capacitor is connected to connection end portions of two adjacent resonance circuits in the N-order composite coil;
providing an M-order composite coil, where the provided M-order composite coil includes M resonance circuits, M is an even number greater than or equal to 2, and a scattering capacitor is connected to connection end portions of two adjacent resonance circuits in the M-order composite coil;
coupling the first resonance circuit in the N-order composite coil to the first resonance circuit in the M-order composite coil to realize WPT;
connecting a load to the N-order composite coil and connecting an alternating current power supply to the M-order composite coil, or, connecting an alternating current power supply to the N-order composite coil and connecting a load to the M-order composite coil; and
adjusting capacitors in two resonance circuits symmetrical to the first resonance circuit in the N-order composite coil and the first resonance circuit in the M-order composite coil among the N+M resonance circuits according to a change in coupling strength between the first resonance circuit in the N-order composite coil and the first resonance circuit in the M-order composite coil in a WPT process to obtain an optimal WPT efficiency.

The present invention provides a third- or higher-order (odd-order) PT symmetry WPT method, frequency tracking is not required for the WPT method by utilizing a unique pure real number eigenfrequency which is unrelated to a coupling distance and is represented by odd-order PT symmetry, and a capacitor size is adjusted according to a change in coupling distance in WPT. Without changing a coil structure or adding additional coils, a better transfer efficiency can be obtained within a larger coupling distance range, and the problem that the transfer efficiency decreases sharply with the increase of a coupling distance in the existing second-order PT symmetry is solved. Compared with a second-order PT symmetric system, a critical coupling strength corresponding to an EP in high-order PT symmetry WPT is smaller, and a corresponding coupling distance is larger, so that an effective WPT distance is larger.

As a further improvement of the high-order PT symmetry WPT method of the present invention, when a scattering capacitor is connected to two adjacent resonance circuits, one end of the scattering capacitor is connected between coils in the two adjacent resonance circuits, and the other end is connected between capacitors in the two adjacent resonance circuits.

As a further improvement of the high-order PT symmetry WPT method of the present invention, the capacitor in the resonance circuit symmetrical to the first resonance circuit in the N-order composite coil among the N+M resonance circuits, the capacitor in the resonance circuit symmetrical to the first resonance circuit in the M-order composite coil, and the scattering capacitor connected between the two resonance circuits symmetrical to the first resonance circuit in the N-order composite coil and the first resonance circuit in the M-order composite coil are adjusted during capacitor adjustment to make a coupling strength formed by the capacitor adjustment equal to a coupling strength between the first resonance circuit in the N-order composite coil and the first resonance circuit in the M-order composite coil.

As a further improvement of the high-order PT symmetry WPT method of the present invention, when the first resonance circuit in the N-order composite coil is located in the middle of the N+M resonance circuits, the resonance circuit symmetrical to the first resonance circuit in the N-order composite coil is the first resonance circuit in the N-order composite coil.

When the first resonance circuit in the M-order composite coil is located in the middle of the N+M resonance circuits, the resonance circuit symmetrical to the first resonance circuit in the M-order composite coil is the first resonance circuit in the M-order composite coil.

As a further improvement of the high-order PT symmetry WPT method of the present invention, N in the N-order composite coil is 3, and M in the M-order composite coil is 2.

The present invention also provides a high-order PT symmetry WPT system, including: an N-order composite coil, including N resonance circuits, where N is an odd number greater than or equal to 1, and when N is greater than or equal to 3, a scattering capacitor is connected to connection end portions of two adjacent resonance circuits in the N-order composite coil;
an M-order composite coil, including M resonance circuits, where M is an even number greater than or equal to 2, and a scattering capacitor is connected to connection end portions of two adjacent resonance circuits in the M-order composite coil, and the first resonance circuit in the N-order composite coil is coupled to the first resonance circuit in the M-order composite coil to realize WPT;
a first port connected to the N-order composite coil, where the first port is connectable to a load or an alternating current power supply;
a second port connected to the M-order composite coil, where the second port is connectable to an alternating current power supply or a load; and
a processing module connected to the N-order composite coil or the M-order composite coil, where the processing module is configured to adjust capacitors in two resonance circuits symmetrical to the first resonance circuit in the N-order composite coil and the first resonance circuit in the M-order composite coil among the N+M resonance circuits according to a change in coupling strength between the first resonance circuit in the N-order composite coil and the first resonance circuit in the M-order composite coil to obtain an optimal power transfer efficiency of the system.

As a further improvement of the high-order PT symmetry WPT system of the present invention, one end of the scattering capacitor is connected between coils in the two adjacent resonance circuits, and the other end is connected between capacitors in the two adjacent resonance circuits.

As a further improvement of the high-order PT symmetry WPT system of the present invention, the processing module adjusts the capacitor in the resonance circuit symmetrical to the first resonance circuit in the N-order composite coil among the N+M resonance circuits, the capacitor in the resonance circuit symmetrical to the first resonance circuit in the M-order composite coil, and the scattering capacitor connected between the two resonance circuits symmetrical to the first resonance circuit in the N-order composite coil and the first resonance circuit in the M-order composite coil during capacitor adjustment to make a coupling strength formed by the capacitor adjustment equal to a coupling strength between the first resonance circuit in the N-order composite coil and the first resonance circuit in the M-order composite coil.

As a further improvement of the high-order PT symmetry WPT system of the present invention, when the first resonance circuit in the N-order composite coil is located in the middle of the N+M resonance circuits, the processing module takes the first resonance circuit in the N-order composite coil as the resonance circuit symmetrical thereto.

When the first resonance circuit in the M-order composite coil is located in the middle of the N+M resonance circuits, the processing module takes the first resonance circuit in the M-order composite coil as the resonance circuit symmetrical thereto.

As a further improvement of the high-order PT symmetry WPT system of the present invention, N in the N-order composite coil is 3, and M in the M-order composite coil is 2.

### BRIEF DESCRIPTION OF THE DRAWINGS

FIG. 1 is an equivalent circuit diagram of a high-order (third-order) PT symmetry WPT system according to the present invention.

FIG. 2 is an equivalent circuit diagram of a first embodiment of a high-order (fifth-order) PT symmetry WPT system according to the present invention.

FIG. 3 is an equivalent circuit diagram of a second embodiment of a high-order (fifth-order) PT symmetry WPT system according to the present invention.

FIG. 4 is an equivalent circuit diagram of a first embodiment of a high-order (seventh-order) PT symmetry WPT system according to the present invention.

FIG. 5 is an equivalent circuit diagram of a second embodiment of a high-order (seventh-order) PT symmetry WPT system according to the present invention.

FIG. 6 is a schematic diagram showing changes of third-order and fifth-order transfer efficiencies of a high-order PT symmetry WPT system and method according to the present invention and a second-order transfer efficiency in the prior art with a distance-to-diameter ratio.

FIG. 7 is a schematic diagram showing changes of third-order and fifth-order transfer efficiencies of a high-order PT symmetry WPT system and method according to the present invention and a second-order transfer efficiency in the prior art with a coupling strength.

FIG. 8 is a flowchart of a high-order PT symmetry WPT method according to the present invention.

### DETAILED DESCRIPTION

The present invention will be further described below with reference to the accompanying drawings and specific embodiments.

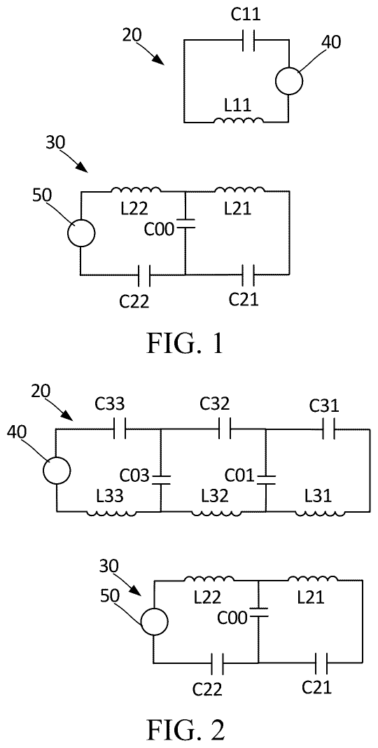

Referring to FIG. 1, the present invention provides a high-order PT symmetry WPT system and method, which are intended to solve the problem in the prior art that the transfer efficiency decreases sharply with the increase of a coupling distance in WPT. The WPT system and method are suitable for transferring wireless power and are used for providing a stable transfer efficiency, so that the transfer efficiency will not decrease sharply due to a change in coupling distance. According to the WPT system and method of the present invention, efficient and stable WPT without frequency tracking is realized by utilizing a unique pure real number eigenfrequency which is unrelated to a coupling distance and is represented by odd-order PT symmetry, and a corresponding capacitor size is adjusted according to a change in coupling distance to realize high-order PT symmetry, thereby realizing an optimal transfer efficiency. The high-order PT symmetry WPT system and method of the present invention will now be described with reference to the accompanying drawings.

FIG. 1 shows an equivalent circuit diagram of a high-order (third-order) PT symmetry WPT system according to the present invention. The high-order PT symmetry WPT system of the present invention will now be described with reference to FIG. 1.

As shown in FIG. 1, the high-order PT symmetry WPT system includes an N-order composite coil 20, an M-order composite coil 30, a first port 40, a second port 50, and a processing module. The N-order composite coil 20 includes N resonance circuits, where N is an odd number greater than or equal to 1. That is, the N-order composite coil 20 is an odd-order composite coil which includes an odd number of resonance circuits. When N is greater than or equal to 3, as shown in combination with FIG. 2, a scattering capacitor is connected to connection end portions of two adjacent resonance circuits in the N-order composite coil 20. The M-order composite coil 30 includes M resonance circuits, where M is an even number greater than or equal to 2. That is, the M-order composite coil 30 is an even-order composite coil which includes an even number of resonance circuits. A scattering capacitor is connected to connection end portions of two adjacent resonance circuits in the M-order composite coil 30. The first resonance circuit in the M-order composite coil 30 is coupled to the first resonance circuit in the N-order composite coil 20 to realize WPT. Specifically: As shown in FIG. 1, a resonance coil L21 in the first resonance circuit of the M-order composite coil 30 is coupled to a resonance coil L11 in the first resonance circuit of the N-order composite coil 20.

The first port 40 is connected to the N-order composite coil 20. The first port 40 is connectable to a load or an alternating current power supply. When the first port 40 is connected to a load, the N-order composite coil 20 serves as a power receiving end and supplies power to the load through the first port 40. When the first port 40 is connected to an alternating current power supply, the N-order composite coil 20 serves as a power transmitting end and supplies power to a corresponding power receiving end.

The second port 50 is connected to the M-order composite coil 30. The second port 50 is connectable to an alternating current power supply or a load. Specifically: When the first port 40 is connected to a load, the second port 50 is connected to an alternating current power supply, the alternating current power supply supplies alternating current to the M-order composite coil 30, the alternating current is transferred to the resonance coil of the first resonance circuit of the N-order composite coil 20 via the resonance coil of the first resonance circuit of the M-order composite coil 30, and then the alternating current is supplied to the load through the first port 40, thereby realizing power supplying or charging for the load. When the first port 40 is connected to an alternating current power supply, the second port 50 is connected to a load, alternating current supplied by the alternating current power supply is transferred to the load through the N-order composite coil 20, M-order composite coil 30, and the second port 50, thereby realizing power supplying or charging for the load.

The processing module is connected to the N-order composite coil 20 or the M-order composite coil 30. The processing module is configured to adjust capacitors in two resonance circuits symmetrical to the first resonance circuit in the N-order composite coil 20 and the first resonance circuit in the M-order composite coil 30 among the N+M resonance circuits according to a change in coupling strength between the first resonance circuit in the N-order composite coil 20 and the first resonance circuit in the M-order composite coil 30 to obtain an optimal power transfer efficiency of the system. N is an odd number, M is an even number, the number of N+M resonance circuits is an odd number, and the odd number of resonance circuits are axisymmetric about a middle resonance circuit, so that the middle resonance circuit among the N+M resonance circuits can be found after the first resonance circuit of the N-order composite coil 20 and the first resonance circuit of the M-order composite coil 30 are connected together. Thus, by taking the middle resonance circuit as an axis, a resonance circuit symmetrical to the first resonance circuit in the N-order composite coil 20 and a resonance circuit symmetrical to the first resonance circuit in the M-order composite coil 30 are obtained, a capacitor connected to the two resonance circuits is set as an adjustable capacitor, and the optimal power transfer efficiency of the system can be obtained by adjusting the capacitor.

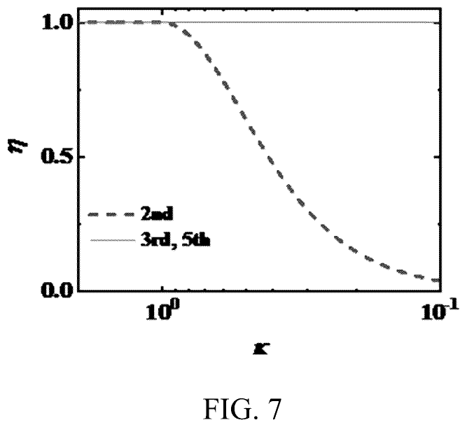

The WPT system of the present invention includes an N-order composite coil 20 and an M-order composite coil 30, where N is an odd number, M is an even number, and the N-order composite coil 20 and the M-order composite coil 30 are coupled to form an odd-order PT symmetry WPT system. By utilizing a unique pure real number eigenfrequency feature which is unrelated to a coupling distance and is represented by odd-order PT symmetry, the N-order composite coil 20 and the M-order composite coil 30 serve as a power transmitting end and a power receiving end respectively in the WPT system of the present invention, transmitting and receiving coils in the N-order composite coil 20 and the M-order composite coil 30 operate under the above pure real number eigenfrequency, and a complex frequency tracking circuit can be omitted. In an embodiment of a WPT method, a coupling distance between coils is changed, a corresponding coupling strength is also changed, and a capacitance value in a composite coil is adjusted to make the coupling strength caused by the capacitance equal to the coupling strength caused by the distance, so as to obtain the optimal transfer efficiency of the system. When the system is in an ideal state (i.e. the system does not have any intrinsic loss), the transfer efficiency of 100% can be realized, and the effect is shown in FIG. 7. In actual situations (the system has a real intrinsic loss), the power transfer efficiency decreases with the decrease of the coupling strength, but decreases more slowly, and the effect is shown in FIG. 6.

Preferably, the resonance circuits in the N-order composite coil 20 and the M-order composite coil 30 each include a capacitor and a coil, and the coils in the first resonance circuits of the N-order composite coil 20 and the M-order composite coil 30 are resonance coils serving as a transmitting coil or a receiving coil, and the resonance coils are distributed coils. The coils in all resonance circuits except the first resonance circuits in the N-order composite coil 20 and the M-order composite coil 30 are lumped inductors. Further: The resonance coil consists of an insulating non-magnetic frame and a wire. The insulating non-magnetic frame is a transparent cylindrical organic glass tube. The wire is a litz wire. The organic glass tube is made of polymethyl methacrylate (PMMA), and has an outer radius of 30 cm, an inner radius of 29.3 cm, a thickness of 0.7 cm, and a length of 6.5 cm. The litz wire is a terylene covered wire with a polyurethane enameled wire as a core wire, has a specification of 0.078*400 strands, a section diameter of about 3.9 mm, and a copper core sectional area of about 1.91 mm2. The litz wire is multi-tightly wound on the side surface of the organic glass tube in preferably 25 turns, and has a cell size smaller than 1/1000 of an operating wavelength, so that the characteristic with a deep sub-wavelength feature can be realized. The lumped inductor is an annular FeSiAl inductor in the model of S106125, 27 mm and 12 A. The capacitors are lumped metalized polyester film direct insertion capacitors capable of resisting a high voltage above 1000 V.

In a specific implementation of the present invention, one end of the scattering capacitor is connected between coils in the two adjacent resonance circuits, and the other end is connected between capacitors in the two adjacent resonance circuits. In an example shown in FIG. 1, the M-order composite coil 30 is a second-order composite coil including two resonance circuits. A resonance coil L21 in the first resonance circuit is connected to a coil L22 in the second resonance circuit, a resonance capacitor C21 in the first resonance circuit is connected to a capacitor C22 in the second resonance circuit, one end of a scattering capacitor C00 is connected between the resonance coil L21 and the coil L22, the other end is connected between the resonance capacitor C21 and the capacitor C22, and the second port 50 is connected between the coil L22 and the capacitor C22. In an example shown in FIG. 2, the N-order composite coil 20 is a third-order composite coil including three resonance circuits. A resonance coil L31 in the first resonance circuit is connected to a coil L32 in the second resonance circuit and a coil L33 in the third resonance circuit, a capacitor C31 in the first resonance circuit is connected to a capacitor C32 in the second resonance circuit and a capacitor C33 in the third resonance circuit, one end of a scattering capacitor C01 is connected between the resonance coil L31 and the coil L32, the other end is connected between the resonance capacitor C32 and the capacitor C32, one end of another scattering capacitor C03 is connected between the resonance coil L32 and the coil L33, the other end is connected between the resonance capacitor C32 and the capacitor C33, and the first port 40 is connected between the coil L33 and the capacitor C33.

In a specific implementation of the present invention, as shown in FIGS. 1 and 2, the processing module adjusts the capacitor in the resonance circuit symmetrical to the first resonance circuit in the N-order composite coil 20 among the N+M resonance circuits, the capacitor in the resonance circuit symmetrical to the first resonance circuit in the M-order composite coil 30, and the scattering capacitor connected between the two resonance circuits symmetrical to the first resonance circuit in the N-order composite coil 20 and the first resonance circuit in the M-order composite coil 30 during capacitor adjustment to make a coupling strength formed by the capacitor adjustment equal to a coupling strength between the first resonance circuit in the N-order composite coil 20 and the first resonance circuit in the M-order composite coil 30.

For example, in FIG. 1, N is 1, M is 2, and the system has 3 resonance circuits. The first resonance circuit in the N-order composite coil 20 and the second resonance circuit in the M-order composite coil 30 are axisymmetric about the first resonance circuit in the M-order composite coil 30, and it can be regarded that the first resonance circuit in the M-order composite coil 30 is symmetrical thereto. In the system shown in FIG. 1, the processing module adjusts the capacitor C21 in the first resonance circuit of the M-order composite coil 30, the capacitor C22 in the second resonance circuit of the M-order composite coil 30, and the scattering capacitor C00 connected between the first resonance circuit and the second resonance circuit of the M-order composite coil 30.

Preferably, in the system shown in FIG. 1, the capacitor in the first resonance circuit, the capacitor in the second resonance circuit, and the scattering capacitor connected between the first resonance circuit and the second resonance circuit in the M-order composite coil 30 are adjustable capacitors.

In the WPT system, when a distance between the power transmitting end and the power receiving end is changed, as shown in conjunction with FIG. 1, i.e., a distance between the resonance coil L11 and the resonance coil L21 is changed, a coupling strength between the resonance coil L11 and the resonance coil L21 is also changed, and the processing module monitors the change in coupling strength between the resonance coil L11 and the resonance coil L21 and adaptively adjusts the capacitor C21, the capacitor C22, and the scattering capacitor C00 according to the change in coupling strength, so that the coupling strength formed by adjusting the capacitor C21, the capacitor C22, and the scattering capacitor C00 is equal to the coupling strength between the resonance coil L11 and the resonance coil L21, the optimal power transfer efficiency of the system is obtained, and the stable power transfer effect of the system is achieved.

In a specific implementation of the present invention, when the first resonance circuit in the N-order composite coil 20 is located in the middle of the N+M resonance circuits, the processing module takes the first resonance circuit in the N-order composite coil 20 as the resonance circuit symmetrical thereto. When the first resonance circuit in the M-order composite coil 30 is located in the middle of the N+M resonance circuits, the processing module takes the first resonance circuit in the M-order composite coil 30 as the resonance circuit symmetrical thereto.

As shown in FIG. 2, in the system shown in FIG. 2, N is 3, M is 2, and there are 5 resonance circuits. If the first resonance circuit in the N-order composite coil 20 and the first resonance circuit in the M-order composite coil 30 are connected, the 5 resonance circuits form a circuit structure axisymmetric about the first resonance circuit in the N-order composite coil 20. A resonance circuit symmetrical to the first resonance circuit in the M-order composite coil 30 is the second resonance circuit in the N-order composite coil 20, and the first resonance circuit of the N-order composite coil 20 is in the middle of the N+M resonance circuits and is symmetrical thereto. When adjusting the capacitors in the system shown in FIG. 2, the processing module adjusts the capacitor C31 of the first resonance circuit, the capacitor C32 of the second resonance circuit, and the scattering capacitor C01 connected between the first resonance circuit and the second resonance circuit in the N-order composite coil 20 to make the coupling strength formed by adjusting the capacitors equal to the coupling strength between the first resonance circuit in the N-order composite coil 20 and the first resonance circuit in the M-order composite coil 30.

Preferably, the capacitor C31 in the first resonance circuit, the capacitor C32 in the second resonance circuit, and the scattering capacitor C01 connected between the first resonance circuit and the second resonance circuit in the N-order composite coil 20 are adjustable capacitors.

In a specific implementation of the present invention, FIG. 1 shows an equivalent circuit diagram of a third-order PT symmetry WPT system. The N-order composite coil 20 is a first-order composite coil, including a resonance circuit. The resonance coil L11 is connected to the capacitor C11 in series, and the first port 40 is connected between the resonance coil L11 and the capacitor C11. The M-order composite coil 30 is a second-order composite coil, including two resonance circuits, the resonance coil L21 is connected to the capacitor C21 in series, the coil L22 is connected to the resonance coil L21 in series, the second port 50 is connected between the coil L22 and the capacitor C22, the capacitor C22 is connected to the resonance capacitor C21, one end of the scattering capacitor C00 is connected between the resonance coil L21 and the coil L22, and the other end is connected between the resonance capacitor C21 and the capacitor C22. The N-order composite coil 20 may be taken as a transmitting end or a receiving end, and correspondingly, the M-order composite coil 30 may be taken as a receiving end or a transmitting end. The resonance coil L21 and the resonance coil L11 are coupled to realize WPT.

In the third-order PT symmetry WPT system, inductance values of the resonance coil L11, the resonance coil L21, and the coil L22 are equal. The capacitor C11 has a fixed value, the capacitor C21, the capacitor C22, and the scattering capacitor C00 are adjustable capacitors, and capacitance values of the capacitor C21 and the capacitor C22 are equal. The capacitor C11, the capacitor C22, and the scattering capacitor C00 conform to the

$$C 11 = \frac{C 00 + C 22}{C 00 C 22} .$$

following relation: The relationship between the capacitor C22, the scattering capacitor C00, and the coupling strength between the resonance coil L21 and the resonance coil L11 is:

$$k = \frac{1}{4 π C 00} \sqrt{\frac{C 22 C 00}{L ( C 22 + C 00 )}} ,$$

where k represents the coupling strength between the resonance coil L21 and the resonance coil L11, and L represents the inductance value of the resonance coil L21.

In the embodiment shown in FIG. 1, corresponding parameter values are set as follows: L21=L21=L11=L=0.737 mH, C11=4.76 nF. The change relation of a coupling strength k caused by a coupling distance d may be approximated as follows: k=16exp(−0.43*d). When the coupling strength k is changed due to the change of the coupling distance d, a corresponding coupling strength k1 caused by adjusting the capacitors C00, C21, and C22 also needs to be changed to ensure that k1=k, so that the optimal power transfer efficiency is obtained. Preferably, as d increases from 0 to 60 cm, C00 increases from 7.95 nF to 149.6 nF, and C22 decreases from 11.86 nF to 4.91 nF. The system can obtain the optimal power transfer efficiency.

Further: When the sizes of the capacitor C21, the capacitor C22, and the scattering capacitor C00 are adjusted, the processing module may quickly calculate the size of the capacitor adapting to the changed coupling strength by using the two relations, and then the capacitor C21, the capacitor C22, and the scattering capacitor C00 are adjusted in place. The processing module may quickly assign a value to the scattering capacitor C00 and then adjust the capacitor C21 and the capacitor C22 step by step, so that the coupling strength of the three capacitors is quickly consistent with the coupling strength k.

Furthermore: The processing module may detect the coupling strength k of the system in real time. Specifically: The processing module may acquire a mutual inductance coefficient between the resonance coil L21 and the resonance coil L11 in real time, and the coupling strength may be obtained by multiplying the mutual inductance coefficient and the resonance frequency of the system. Preferably, the coupling strength between the resonance coil L21 and the resonance coil L11 may be directly obtained by connecting a network analyzer to the receiving end or the transmitting end. The processing module may also detect the coupling distance between the resonance coil L21 and the resonance coil L11 in the system in real time, and the coupling strength is calculated through the coupling distance.

Furthermore: A transmission coefficient of the system may be measured in real time through the network analyzer, and the power transfer efficiency of the system may be calculated by using the transmission coefficient. The power transfer efficiency is η=|S|², where S represents a transmission system.

In the present embodiment, the relationship between resonance frequencies f₀ of the resonance coil L21 and the resonance coil L11, inductance values L of the coils, and resonance capacitors C is:

$${f}_{0} = \frac{1}{2 π \sqrt{LC}} .$$

Furthermore: The coils except the resonance coil L21 in the M-order composite coil 30 and the capacitors in the present embodiment may be integrated on one printed circuit board (PCB), so that the system space can be saved, the resonance coil L21 is electrically connected to the PCB, and the resonance coil L21 is arranged nearby the PCB.

In a specific implementation of the present invention, FIG. 2 shows an equivalent circuit diagram of a fifth-order PT symmetry WPT system. N in the N-order composite coil 20 is 3, and M in the M-order composite coil 30 is 2. A specific connection of the circuit is shown in FIG. 2. Similarly, the N-order composite coil 20 may be taken as a transmitting end or a receiving end. Correspondingly, the M-order composite coil 30 may be taken as a receiving end or a transmitting end. The resonance coil L21 and the resonance coil L31 are coupled to realize WPT.

In the first fifth-order PT symmetry system, inductance values of the resonance coil L21, the resonance coil L31, the coil L22, the coil L32, and the coil L33 are equal. The capacitor C22, the capacitor C21, the scattering capacitor C00, and the capacitor C33 have fixed values, the capacitance values of the capacitor C21 and the capacitor C22 are equal, the capacitance values of the scattering capacitor C03 and the scattering capacitor C00 are equal, and the relationship between an equivalent capacitor C of the M-order composite coil 30, the scattering capacitor C00, and the capacitor C22 is:

$$C = \frac{C 00 + C 22}{C 00 C 22} .$$

The capacitor C31, the scattering capacitor C01, and the capacitor C32 are adjustable capacitors, relations of the scattering capacitor C01, the capacitor C31, and the capacitor C32 are:

$$C 31 = \frac{C 00 C}{C 00 - 2 C} , and C 32 = \frac{C 00 C 01 C}{C 00 C 01 - CC 10 - CC 00} ,$$

relations of the scattering capacitor C01, the capacitor C32, the capacitor C31, and the coupling strength k between the resonance coil L21 and the resonance coil L31 are:

$$k = \frac{{f}_{0} C}{2 C 01} , and {f}_{0} = \frac{1}{2 π \sqrt{LC}} ,$$

where k represents the coupling strength between the resonance coil L21 and the resonance coil L31, L represents the inductance value of the resonance coil L21, C represents the equivalent capacitance of the M-order composite coil 30, and f₀ represents the resonance frequency of the resonance coil L21 and the resonance coil L31.

In the embodiment shown in FIG. 2, corresponding parameter values are set as follows: L21=L22=L31=L32=L33=L=0.737 mH, C=4.76 nF, and f₀=85 KHz. The change relation of a coupling strength k caused by a coupling distance d is approximated as follows: k=16 exp(−0.43*d). When the coupling strength k is changed due to the change of the coupling distance d, a corresponding coupling strength k1 caused by adjusting capacitors C01, C31, and C32 also needs to be changed to ensure that k1=k. Preferably, as d increases from 0 to 60 cm, C01 increases from 10.97 nF to 149.6 nF, C31 decreases from 36.01 nF to 5.08 nF, and C32 decreases from 14.95 nF to 5.38 nF. The system may obtain the optimal transfer efficiency.

In addition, to reduce adjustable parameters of the system, it is also necessary to fix related parameters: C00=C03=57.43 nF, C21=C22=C33=5.19 nF, so that a coupling strength k2 caused by branch capacitors C00 and C03 satisfies the relation:

$${k}_{2} = \frac{{f}_{0} C}{2 C 00} = \frac{{f}_{0} C}{2 C 03} .$$

Further: When the sizes of the capacitors are adjusted, the processing module may quickly calculate the size of the capacitor adapting to the changed coupling strength by using the relation, and then the capacitor C31, the capacitor C32, and the scattering capacitor C01 are adjusted in place. The processing module may quickly assign a value to the scattering capacitor C01 and then adjust the capacitor C31 and the capacitor C32 step by step, so that the coupling strength of the three capacitors is quickly consistent with the coupling strength k.

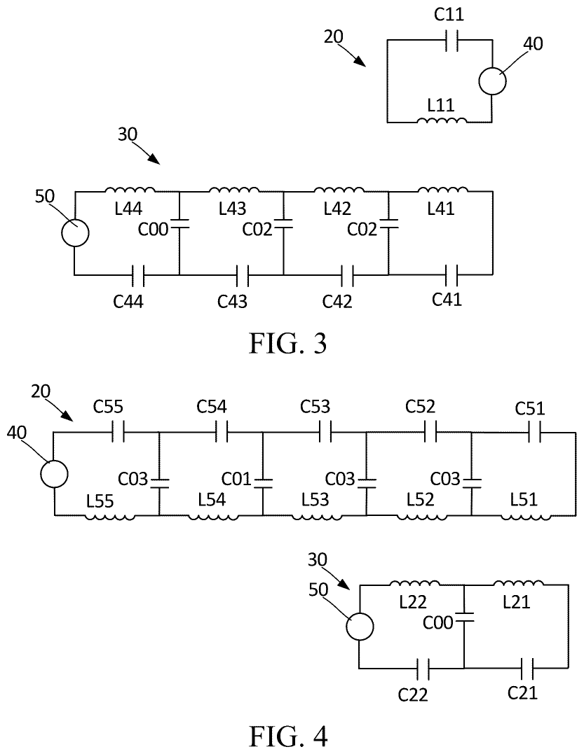

In a specific implementation of the present invention, FIG. 3 shows an equivalent circuit diagram of another fifth-order PT symmetry WPT system. N in the N-order composite coil 20 is 1, and M in the M-order composite coil 30 is 4. A specific connection of the circuit is shown in FIG. 3. Similarly, the N-order composite coil 20 may be taken as a transmitting end or a receiving end. Correspondingly, the M-order composite coil 30 may be taken as a receiving end or a transmitting end. The resonance coil L11 and a resonance coil L41 are coupled to realize WPT. At this moment, a capacitor C43, a scattering capacitor C00, and a capacitor C44 are adjustable capacitors, and the other capacitors have fixed values.

In a specific implementation of the present invention, FIG. 4 shows an equivalent circuit diagram of a seventh-order PT symmetry WPT system. N in the N-order composite coil 20 is 5, and M in the M-order composite coil 30 is 2. A specific connection of the circuit is shown in FIG. 4. Similarly, the N-order composite coil 20 may be taken as a transmitting end or a receiving end. Correspondingly, the M-order composite coil 30 may be taken as a receiving end or a transmitting end. The resonance coil L21 and a resonance coil L51 are coupled to realize WPT. In the present embodiment, a capacitor C53, a scattering capacitor C01, and a capacitor C54 may be adjustable capacitors, and the other capacitors may have fixed values.

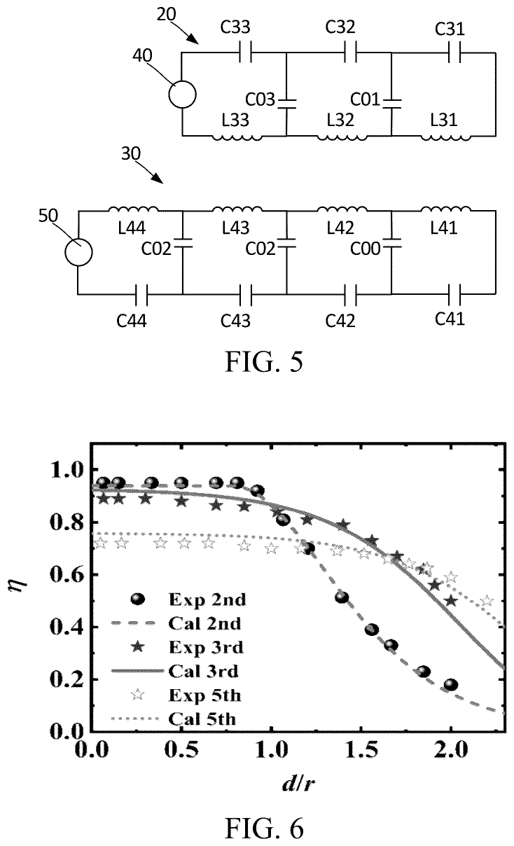

In a specific implementation of the present invention, FIG. 5 shows another equivalent circuit diagram of a seventh-order PT symmetry WPT system. N in the N-order composite coil 20 is 3, and M in the M-order composite coil 30 is 4. A specific connection of the circuit is shown in FIG. 5. Similarly, the N-order composite coil 20 may be taken as a transmitting end or a receiving end. Correspondingly, the M-order composite coil 30 may be taken as a receiving end or a transmitting end. The resonance coil L31 and the resonance coil L41 are coupled to realize WPT. In the present embodiment, a capacitor C41, a scattering capacitor C00, and a capacitor C42 may be adjustable capacitors, and the other capacitors may have fixed values.

The third-order PT symmetry WPT system shown in FIG. 1 and the fifth-order PT symmetry WPT system shown in FIG. 2 are provided for performing WPT experiments with the existing second-order PT symmetry WPT system. As shown in FIG. 6, changes of transfer efficiencies of three systems with a distance-to-diameter ratio under the same conditions are shown. In FIG. 6, a curve formed by combining solid spheres and a dotted line is a transfer efficiency change curve of a second-order system, a curve formed by combining solid stars and a solid line is a transfer efficiency change curve of a third-order system, and a curve formed by combining solid stars and a dotted line is a transfer efficiency change curve of a fifth-order system. As can be seen from FIG. 6, when the transfer efficiency decreases to 50%, the distance-to-diameter ratios of the second-order, third-order, and fifth-order wireless transfer systems are 1, 1.4, and 1.6, respectively. Under the same conditions, as the order is higher, an effective transfer distance is larger. The distance-to-diameter ratio is a ratio of a coupling distance to a winding radius of a resonance coil. Regardless of the intrinsic loss of the system, the changes of the transfer efficiencies of the above three systems with the coupling strength are as shown in FIG. 7, the coupling strength is related to the coupling distance, and as the coupling strength is smaller, the coupling distance is larger. As can be seen from FIG. 7, the transfer efficiency of the second-order system in a weak coupling region decreases rapidly as the coupling strength decreases, while the third-order and fifth-order systems can ensure transfer efficiency of 100% that is not changed as the coupling strength is changed. Although theoretically, the power transfer efficiency of the WPT system is not affected by the coupling distance, the coupling distance is within a certain range, and the stability of the transfer efficiency of the system is optimal, and the range of the coupling distance is preferably about 1.5 times the radius of the resonance coil.

The present invention also provides a high-order PT symmetry WPT method, including the following steps:

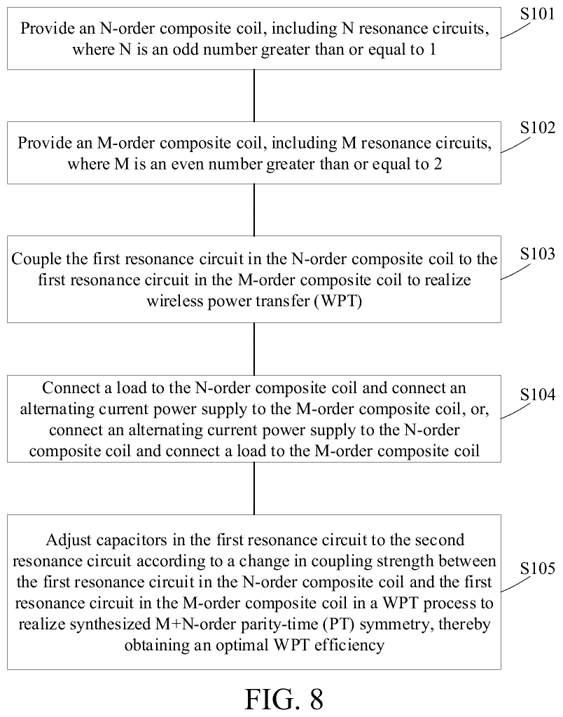

As shown in FIG. 8, step S101 is executed. An N-order composite coil is provided, where the provided N-order composite coil includes N resonance circuits, N is an odd number greater than or equal to 1, and when N is greater than or equal to 3, a scattering capacitor is connected to connection end portions of two adjacent resonance circuits in the N-order composite coil. Then step S102 is executed.

Step S102 is executed. An M-order composite coil is provided, where the provided M-order composite coil includes M resonance circuits, M is an even number greater than or equal to 2, and a scattering capacitor is connected to connection end portions of two adjacent resonance circuits in the M-order composite coil. Then step S103 is executed.

Step S103 is executed. The first resonance circuit in the N-order composite coil is coupled to the first resonance circuit in the M-order composite coil to realize WPT. Then step S104 is executed.

Step S104 is executed. The N-order composite coil is connected to a load and the M-order composite coil is connected to an alternating current power supply, or, the N-order composite coil is connected to an alternating current power supply and the M-order composite coil is connected to a load. Then step S105 is executed.

Step S105 is executed. Capacitors in two resonance circuits symmetrical to the first resonance circuit in the N-order composite coil and the first resonance circuit in the M-order composite coil among the N+M resonance circuits are adjusted according to a change in coupling strength between the first resonance circuit in the N-order composite coil and the first resonance circuit in the M-order composite coil in a WPT process to realize synthesized N+M-order PT symmetry, thereby obtaining an optimal WPT efficiency.

In a specific implementation of the present invention, when a scattering capacitor is connected, one end of the scattering capacitor is connected between coils in the two adjacent resonance circuits, and the other end is connected between capacitors in the two adjacent resonance circuits.

In a specific implementation of the present invention, the capacitor in the resonance circuit symmetrical to the first resonance circuit in the N-order composite coil among the N+M resonance circuits, the capacitor in the resonance circuit symmetrical to the first resonance circuit in the M-order composite coil, and the scattering capacitor connected between the two resonance circuits symmetrical to the first resonance circuit in the N-order composite coil and the first resonance circuit in the M-order composite coil are adjusted during capacitor adjustment to make a coupling strength formed by the capacitor adjustment equal to a coupling strength between the first resonance circuit in the N-order composite coil and the first resonance circuit in the M-order composite coil.

In a specific implementation of the present invention, when the first resonance circuit in the N-order composite coil is located in the middle of the N+M resonance circuits, the resonance circuit symmetrical to the first resonance circuit in the N-order composite coil is the first resonance circuit in the N-order composite coil.

When the first resonance circuit in the M-order composite coil is located in the middle of the N+M resonance circuits, the resonance circuit symmetrical to the first resonance circuit in the M-order composite coil is the first resonance circuit in the M-order composite coil.

In a specific implementation of the present invention, N in the N-order composite coil is 3, and M in the M-order composite coil is 2.

The present invention is described above in detail with reference to the embodiments of the accompanying drawings, and a person of ordinary skill in the art may make various modifications to the present invention according to the above description. Therefore, some details in the embodiments shall not constitute a limitation on the present invention, and the protection scope of the present invention shall be subject to the scope of the appended claims.

What is claimed is:

1. A high-order parity-time (PT) symmetry wireless power transfer (WPT) method, comprising the following steps:
providing an N-order composite coil, wherein the provided N-order composite coil comprises N resonance circuits, N is an odd number greater than or equal to 1, and when N is greater than or equal to 3, a scattering capacitor is connected to connection end portions of two adjacent resonance circuits in the N-order composite coil;
providing an M-order composite coil, wherein the provided M-order composite coil comprises M resonance circuits, M is an even number greater than or equal to 2, and a scattering capacitor is connected to connection end portions of two adjacent resonance circuits in the M-order composite coil;
coupling the first resonance circuit in the N-order composite coil to the first resonance circuit in the M-order composite coil to realize WPT;
connecting a load to the N-order composite coil and connecting an alternating current power supply to the M-order composite coil, or, connecting an alternating current power supply to the N-order composite coil and connecting a load to the M-order composite coil; and
adjusting capacitors in two resonance circuits symmetrical to the first resonance circuit in the N-order composite coil and the first resonance circuit in the M-order composite coil among the N+M resonance circuits according to a change in coupling strength between the first resonance circuit in the N-order composite coil and the first resonance circuit in the M-order composite coil in a WPT process to obtain an optimal WPT efficiency.

2. The high-order PT symmetry WPT method according to claim 1, wherein when a scattering capacitor is connected to two adjacent resonance circuits, one end of the scattering capacitor is connected between coils in the two adjacent resonance circuits, and the other end is connected between capacitors in the two adjacent resonance circuits.

3. The high-order PT symmetry WPT method according to claim 1, wherein the capacitor in the resonance circuit symmetrical to the first resonance circuit in the N-order composite coil among the N+M resonance circuits, the capacitor in the resonance circuit symmetrical to the first resonance circuit in the M-order composite coil, and the scattering capacitor connected between the two resonance circuits symmetrical to the first resonance circuit in the N-order composite coil and the first resonance circuit in the M-order composite coil are adjusted during capacitor adjustment to make a coupling strength formed by the capacitor adjustment equal to a coupling strength between the first resonance circuit in the N-order composite coil and the first resonance circuit in the M-order composite coil.

4. The high-order PT symmetry WPT method according to claim 3, wherein when the first resonance circuit in the N-order composite coil is located in the middle of the N+M resonance circuits, the resonance circuit symmetrical to the first resonance circuit in the N-order composite coil is the first resonance circuit in the N-order composite coil; and
when the first resonance circuit in the M-order composite coil is located in the middle of the N+M resonance circuits, the resonance circuit symmetrical to the first resonance circuit in the M-order composite coil is the first resonance circuit in the M-order composite coil.

5. The high-order PT symmetry WPT method according to claim 1, wherein N in the N-order composite coil is 3, and M in the M-order composite coil is 2.

6. A high-order parity-time (PT) symmetry wireless power transfer (WPT) system, comprising:
an N-order composite coil, comprising N resonance circuits, wherein N is an odd number greater than or equal to 1, and when N is greater than or equal to 3, a scattering capacitor is connected to connection end portions of two adjacent resonance circuits in the N-order composite coil;
an M-order composite coil, comprising M resonance circuits, wherein M is an even number greater than or equal to 2, and a scattering capacitor is connected to connection end portions of two adjacent resonance circuits in the M-order composite coil, and the first resonance circuit in the N-order composite coil is coupled to the first resonance circuit in the M-order composite coil to realize WPT;
a first port connected to the N-order composite coil, where the first port is connectable to a load or an alternating current power supply;
a second port connected to the M-order composite coil, where the second port is connectable to an alternating current power supply or a load; and
a processing module connected to the N-order composite coil or the M-order composite coil, the processing module being configured to adjust capacitors in resonance circuits symmetrical to the first resonance circuit in the N-order composite coil and the first resonance circuit in the M-order composite coil among the N+M resonance circuits according to a change in coupling strength between the first resonance circuit in the N-order composite coil and the first resonance circuit in the M-order composite coil to obtain an optimal power transfer efficiency of the system.

7. The high-order PT symmetry WPT system according to claim 6, wherein one end of the scattering capacitor is connected between coils in the two adjacent resonance circuits, and the other end is connected between capacitors in the two adjacent resonance circuits.

8. The high-order PT symmetry WPT system according to claim 6, wherein the processing module adjusts the capacitor in the resonance circuit symmetrical to the first resonance circuit in the N-order composite coil among the N+M resonance circuits, the capacitor in the resonance circuit symmetrical to the first resonance circuit in the M-order composite coil, and the scattering capacitor connected between the two resonance circuits symmetrical to the first resonance circuit in the N-order composite coil and the first resonance circuit in the M-order composite coil during capacitor adjustment to make a coupling strength formed by the capacitor adjustment equal to a coupling strength between the first resonance circuit in the N-order composite coil and the first resonance circuit in the M-order composite coil.

9. The high-order PT symmetry WPT system according to claim 6, wherein when the first resonance circuit in the N-order composite coil is located in the middle of the N+M resonance circuits, the processing module takes the first resonance circuit in the N-order composite coil as the resonance circuit symmetrical thereto; and
when the first resonance circuit in the M-order composite coil is located in the middle of the N+M resonance circuits, the processing module takes the first resonance circuit in the M-order composite coil as the resonance circuit symmetrical thereto.

10. The high-order PT symmetry WPT system according to claim 6, wherein N in the N-order composite coil is 3, and M in the M-order composite coil is 2.
